(19) United States
(12) Patent Application Publication
(10) Pub. No.: US 2018/0025731 A1
(43) Pub. Date: Jan. 25, 2018

(54) Cascading Specialized Recognition Engines Based on a Recognition Policy

(71) Applicant: Andrew Lovitt, Redmond, WA (US)

(72) Inventor: Andrew Lovitt, Redmond, WA (US)

(21) Appl. No.: 15/216,576

(22) Filed: Jul. 21, 2016

(51) Int. Cl. G10L 17/10; G10L 15/28

(52) U.S. Cl. CPC G10L 17/10; G10L 15/285

(57) ABSTRACT

Specialized recognition engines are configured to recognize acoustic objects. A policy engine can consume a recognition policy that defines the conditions under which specialized recognition engines are to be activated or deactivated. An arbitrator receives events fired by the specialized recognition engines and provides the events to listeners that have registered to receive notification of the occurrence of the events. If a specialized recognition engine recognizes an acoustic object, the policy engine can utilize the recognition policy to identify the specialized recognition engines that are to be activated or deactivated. The identified specialized recognition engines can then be activated or deactivated in order to implement a particular recognition scenario and to meet a particular power consumption requirement.

### BACKGROUND

Many types of computing devices utilize speech-driven user interfaces (“UIs”). In some of these types of computing devices, only a single key phrase can be utilized to activate the speech-driven UI or drive a specific action or set of actions. A computing device might be limited to the use of a single key phrase for activating the device in order to reduce the power consumption of the device when the speech-driven UI is not being utilized.

It is desirable to enable speech-driven computing devices to have interaction models that utilize more than one key phrase. In order to enable this functionality, large speech recognizers capable of recognizing a large number of key phrases are typically utilized. These types of recognizers are, however, typically inappropriate for use with devices operating in a low power state, particularly those that are powered by batteries.

It is with respect to these and other considerations that the disclosure made herein is presented.

### SUMMARY

Technologies are described herein for cascading specialized recognition engines based on a recognition policy. Through an implementation of the disclosed technologies, specialized recognition engines can be activated or deactivated based upon a recognition policy in order to implement a desired recognition scenario and power consumption requirement. In this way, an implementation of the technologies disclosed herein can reduce the power required by a computing device to recognize particular words, phrases, or other types of acoustic objects, particularly when operating in a low power state, as compared to previous speech recognition technologies. Technical benefits other than those specifically identified herein can also be realized through an implementation of the disclosed technologies.

According to one configuration disclosed herein, a number of specialized recognition engines are provided. The specialized recognition engines are software or hardware components that are each configured to recognize a relatively small number (e.g. one to five) of acoustic objects. Acoustic objects can include, but are not limited to, sounds, noises, spoken words or phrases, music, other types of acoustic energy, or a lack of acoustic energy. Each specialized recognition engine can have an associated model for use in recognizing the acoustic objects. Each specialized recognition engine can also have an associated recognition threshold that defines the level of certainty that an acoustic object has been recognized that is required in order for a specialized recognition engine to fire an event indicating that the acoustic object has been recognized. Each of the specialized recognition engines can receive captured audio, and potentially other ancillary signals, and fire one or more events or take other actions if an acoustic object is recognized.

A policy engine is also utilized in some configurations. The policy engine is a software or hardware component configured to consume a recognition policy that defines the conditions under which specialized recognition engines are to be activated or deactivated. The recognition policy can also define other aspects of the manner in which the specialized recognition engines are to be activated such as, for instance, changing the recognition threshold associated with a specialized recognition engine.

An arbitrator can also be utilized in some configurations. The arbitrator is a software or hardware component that receives the events fired by the specialized recognition engines and can provide the events to listeners that have registered to receive notification of the occurrence of the events. The arbitrator can also arbitrate between events fired by specialized recognition engines configured to recognize the same acoustic objects. The arbitrator can utilize the recognition policy to determine how to arbitrate between the various events.

If the arbitrator receives an event fired by one of the specialized recognition engines, the arbitrator can generate a notification to a registered listener, or listeners. The notification can identify the recognized acoustic object. The notification might also provide the contents of an audio buffer before, during, and/or after the recognized acoustic object. The listener can utilize the contents of the audio buffer, for example, to validate the recognition of the acoustic object and/or for other purposes. A listener can also modify the recognition policy in some configurations.

In some configurations, the specialized recognition engines, the policy engine, and the arbitrator can execute on a digital signal processor (“DSP”) while the listeners execute on a system on a chip (“SoC”). In other configurations, some or all of the specialized recognition engines, the policy engine, the arbitrator, and the listeners can execute on a DSP, a central processing unit (“CPU”), floating point gate array (“FPGA”), as a network service, a network service accessible via a wide-area network such as the Internet (commonly referred to as a “Cloud” service) or in another manner. Other configurations can also be utilized.

Using the components described briefly above, a first specialized recognition engine configured to recognize a first acoustic object (e.g. the spoken phrase “Hi”) can be activated on a computing system. If the first specialized recognition engine recognizes the first acoustic object, the policy engine can cause a second specialized recognition engine configured to recognize a second acoustic object to be activated on the computing system. The policy engine can utilize the recognition policy to determine which specialized recognition engine, or engines, are to be activated. The recognition threshold associated with the first specialized recognition engine can also be modified. Alternately, the first specialized recognition engine might be deactivated in order to reduce power consumption.

In some configurations, the second specialized recognition engine can be deactivated when the computing system enters a low power state. The second specialized recognition engine can be reactivated when the computing system exits the low power state.

If the second specialized recognition engine recognizes the second acoustic object, the policy engine might activate a third specialized recognition engine configured to recognize a third acoustic object based on the recognition policy. In this manner, specialized recognition engines can be activated in cascading manner, or deactivated, based upon the recognition policy in order to implement a particular speech-driven UI and to meet desired power consumption requirements.

It should be appreciated that the subject matter described briefly above and in greater detail below can be implemented as a computer-controlled apparatus, a computer process, a computing device, or as an article of manufacture, such as a computer readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a software architecture diagram showing aspects of the configuration and operation of a system disclosed herein for cascading specialized recognition engines based on a recognition policy, according to one particular configuration;

FIG. 2 is a system diagram showing aspects of the activation and operation of an example set of specialized recognition engines executing on a computing system in one particular configuration;

FIG. 3 is a system diagram showing aspects of the activation and operation of another example set of specialized recognition engines executing on a computing system in one particular configuration;

FIG. 4 is a flow diagram showing aspects of a routine for cascading specialized recognition engines based on a recognition policy, according to one particular configuration;

FIG. 5 is a schematic diagram showing an example configuration for a head mounted augmented reality display device that can be utilized to implement aspects of the various technologies disclosed herein;

FIG. 6 is a computer architecture diagram showing an illustrative computer hardware and software architecture for a computing device that is capable of implementing aspects of the technologies presented herein;

FIG. 7 is a computer system architecture and network diagram illustrating a distributed computing environment capable of implementing aspects of the technologies presented herein; and

FIG. 8 is a computer architecture diagram illustrating a computing device architecture for a mobile computing device that is capable of implementing aspects of the technologies presented herein.

### DETAILED DESCRIPTION

The following detailed description is directed to technologies for cascading specialized recognition engines based on a recognition policy. As discussed briefly above, through an implementation of the technologies disclosed herein, specialized recognition engines can be activated in a cascading manner and deactivated based upon a recognition policy in order to implement a desired recognition scenario and power consumption requirement. In this way, an implementation of the technologies disclosed herein can reduce the power required by a computing device to recognize particular words, phrases, or other types of acoustic objects as compared to previous recognition technologies. Technical benefits other than those specifically identified herein can also be realized through an implementation of the disclosed subject matter.

While the subject matter described herein is presented in the general context of program modules that execute in conjunction with the execution of an operating system and application programs on a computing system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations including, but not limited to, head mounted augmented reality display devices, head mounted virtual reality (“VR”) devices, hand-held computing devices, desktop or laptop computing devices, slate or tablet computing devices, server computers, multiprocessor systems, microprocessor-based or programmable consumer electronics, networked server computers, smartphones, game consoles, set-top boxes, and other types of computing devices.

In the following detailed description, references are made to the accompanying drawings that form a part hereof, and which are shown by way of illustration as specific configurations or examples. Referring now to the drawings, in which like numerals represent like elements throughout the several FIGS., aspects of various technologies for cascading specialized recognition engines based on a recognition policy will be described.

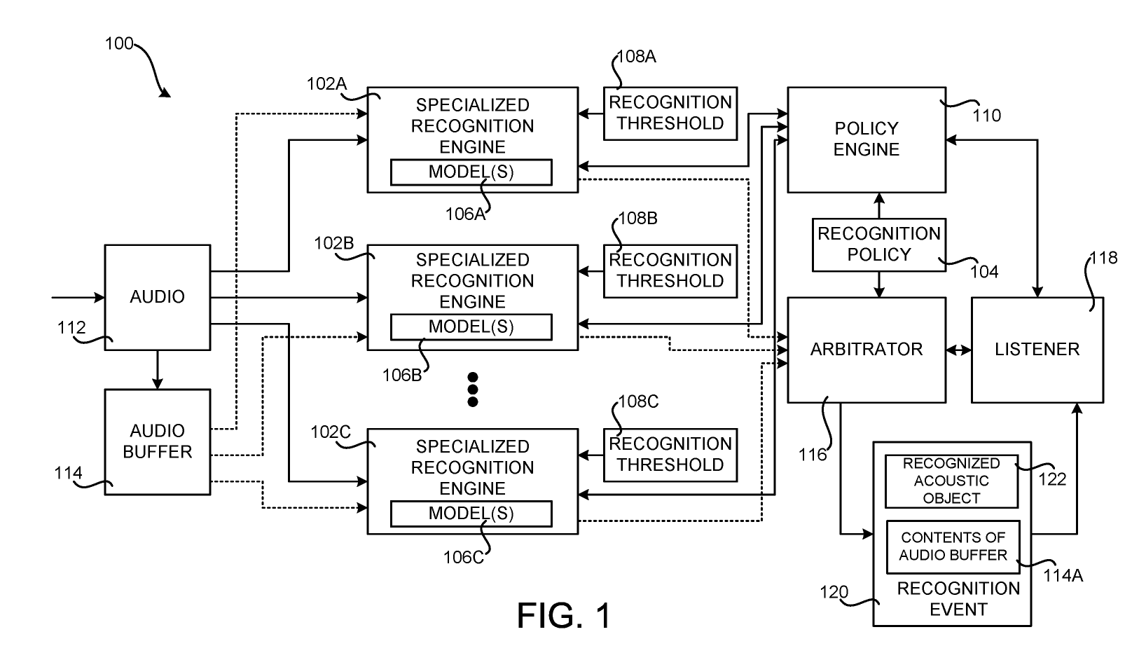

FIG. 1 is a software architecture diagram showing aspects of the configuration and operation of a system 100 disclosed herein for cascading specialized recognition engines 102 based on a recognition policy 104, according to one particular configuration. As shown in FIG. 1 and described briefly above, the system 100 includes several specialized recognition engines 102A-102C (which might be referred to collectively as the specialized recognition engines 102 or individually as a specialized recognition engine 102) in one particular configuration. The specialized recognition engines 102 might also be referred to herein as “keyword spotters” or “key phrase detectors.”

The specialized recognition engines 102 are software or hardware components that are each configured to recognize a relatively small number (e.g. one to five) of acoustic objects. The specialized recognition engines 102 can be configured to recognize specific words or phrases that provide high accuracy and have a small footprint. As will be discussed in greater detail below, the specialized recognition engines 102 can be of such a size that multiple specialized recognition engines 102 can be executed on a DSP simultaneously.

As also mentioned briefly above, the acoustic objects recognizable by the specialized recognition engines 102 can include, but are not limited to, sounds, noises, spoken words or phrases, music, other types of acoustic energy, or a lack of acoustic energy. The acoustic objects recognizable by the specialized recognition engines 102 can be present in audio 112 that is captured by a computing device, digitized, and routed to the specialized recognition engines 102. The digitized audio 112 can also be buffered in the audio buffer 114. As will be discussed in greater detail below, audio 112 from the audio buffer 114 can also be routed to the specialized recognition engines 102 or to a listener 118 (described below) in some configurations. In other configurations, the specialized recognition engines 102 operate on analog data.

Each of specialized recognition engines 102A-102C can have one or more associated models 106A-106C, respectively, for use in recognizing acoustic objects. For example, and without limitation, a model for a specialized recognition engine 102 can be configured to detect one or more acoustic objects. For example, and without limitation, an acoustic model 106 can be configured to recognize three key phrases simultaneously (e.g. “Hi”, “Play”, and “Stop”). Other types of models can also be utilized.

Each specialized recognition engine 102A-102C can also have one or more associated recognition thresholds 108A-108C, respectively, that define the level of certainty that an acoustic object has been recognized that is required in order for a specialized recognition engine 102 to fire an event indicating that the acoustic object has been recognized or take another type of action. Each acoustic object recognizable by a specialized recognition engine 102 can also have an independent recognition threshold 108 or multiple acoustic objects can have the same recognition threshold 108.

Each of the specialized recognition engines can receive captured audio 112 and fire one or more events and/or take other types of actions if the associated model 106 recognizes an acoustic object. Multiple acoustic objects can be mapped to the same event. For example, a model 106 might be configured to recognize four phrases: “Hi”; “Hey”; “Hello”; and “Play.” In this example, recognition of the first three phrases would trigger the same event while recognition of the last phrase would trigger a different event.

A policy engine 110 is also utilized in some configurations. The policy engine 110 is a software or hardware component configured to consume a recognition policy 104 that defines the conditions under which specialized recognition engines 102 are to be activated or deactivated. The recognition policy 104 can also define other aspects of the manner in which the specialized recognition engines 102 are to be activated such as, for instance, changing one or more of the recognition thresholds 108 associated with a specialized recognition engine 102. When a specialized recognition engine 102 recognizes an acoustic object, an event or another type of notification can be provided to the policy engine 110 that identifies the acoustic object that was recognized. Additional details regarding the operation of the policy engine 110 will be provided below.

An arbitrator 116 can also be utilized in some configurations. The arbitrator 116 is a software or hardware component that also receives events fired by the specialized recognition engines 102. The arbitrator 116, in turn, can provide the events to listeners 118 that have registered to receive notification of the occurrence of the events. In the example configuration shown in FIG. 1, for instance, the arbitrator 116 has provided a recognition event 120 to the listener 118.

As shown in FIG. 1, the recognition event 120 includes data 122 identifying the recognized acoustic object. The recognition event 120 can also include the contents 114A of the audio buffer 114 before, during, and/or after the audio 12 corresponding to the recognized acoustic object. The listener 118 can utilize the contents of the audio buffer 114A, for example, to validate the recognition of the acoustic object and/or for other purposes. As will be described in greater detail below, a listener 118 can also communicate with the policy engine 110 to modify the recognition policy 104 and to perform other types of functionality in some configurations.

The arbitrator 116 can also arbitrate between events fired by specialized recognition engines 102 configured to recognize the same acoustic objects. The arbitrator 116 can utilize the recognition policy 104 to determine how to arbitrate between the various events. A recognition event 120 can then be provided to a listener 118, or listeners 118, depending upon the outcome of the arbitration. The arbitrator 116 can also perform other types of functionality in other configurations.

In some configurations, the specialized recognition engines 102, the policy engine 110, and the arbitrator 116 can execute on a DSP while the listeners 118 execute on a SoC. In other configurations, some or all of the specialized recognition engines 102, the policy engine 110, the arbitrator 116, and the listeners 118 can execute on a DSP, a CPU, FPGA, a network service, or in another manner. In this regard, it is to be appreciated that the configuration in FIG. 1 is merely illustrative and that many more specialized recognition engines 102 and listeners 118 can be utilized than illustrated. Other configurations can also be utilized.

It is also to be appreciated that data obtained from sensors in a computing device can be utilized to trigger activation of the specialized recognition engines 102. For instance, and without limitation, an accelerometer can indicate that a computing device has been picked up and, in response thereto, cause one or more of the specialized recognition engines 102 to be activated or deactivated. The specialized recognition engines 102 can also be activated or deactivated based upon other types of signals generated by a computing system implementing the technologies disclosed herein.

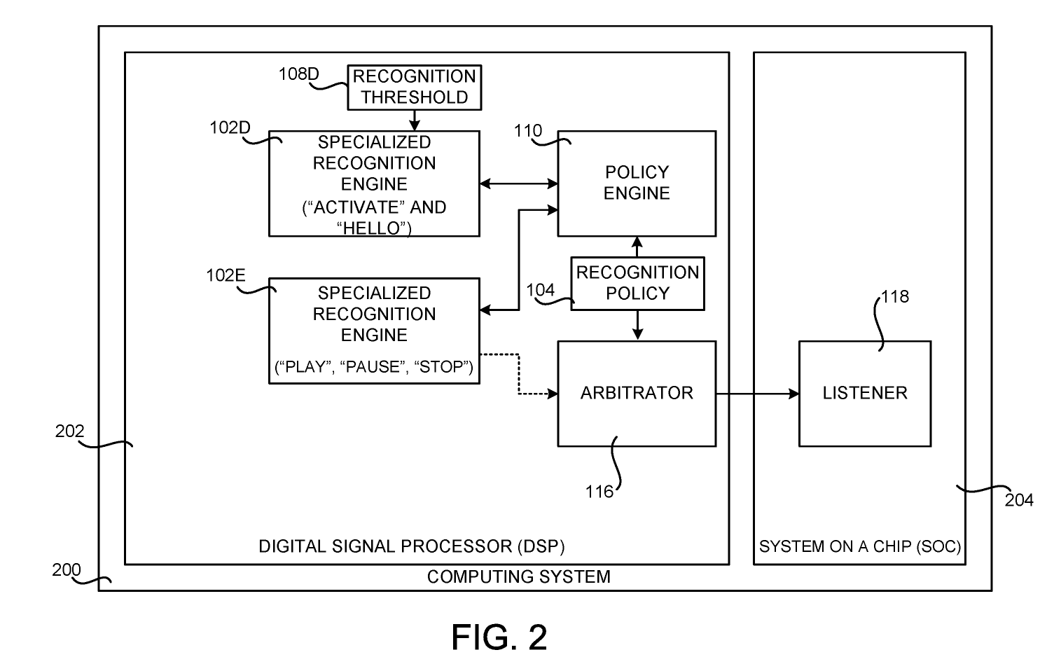

Using the components described briefly above, specialized recognition engines 102 can be activated or deactivated according to the recognition policy 104. The recognition policy 104 can be defined to cause the specialized recognition engines 102 to be activated and deactivated in order to implement a particular recognition scenario and to achieve a desired power consumption requirement for a computing device implementing the system 100. Additional details regarding the components shown in FIG. 1 will be provided below with regard to FIGS. 2-4.

FIG. 2 is a system diagram showing aspects of the activation and operation of an example set of specialized recognition engines 102 executing on a computing system 200 in one particular configuration. The computing system 200 includes a DSP 202 and an SoC 204. In this example, the specialized recognition engines 102, the policy engine 110, and the arbitrator 116 are executed on the DSP while the listener 118 is executed on the SoC 204. As mentioned above, it is to be appreciated that this configuration is only illustrative and that these components can execute in other locations in other configurations.

In the example shown in FIG. 2, the specialized recognition engine 102D is configured to recognize two phrases: “Activate” and “Hello.” In this example, the recognition policy 104 specifies that if either of these two phrases are recognized, then the specialized recognition engine 102E is to be activated. Alternately, the recognition policy 104 could specify that different actions (e.g. the activation of a specialized recognition engine 102) are to be taken for each of the different phrases. The specialized recognition engine 102E is configured to recognize three phrases: “Play”; “Pause”; and “Stop”).

If the specialized recognition engine 102D recognizes either “Activate” or “Hello,” it will transmit a recognition event to the policy engine 110 (and possibly to the arbitrator 116). In turn, the policy engine 110 will utilize the recognition event and the recognition policy 104 to determine that the specialized recognition engine 102E is to be activated. The policy engine 110 can then cause the specialized recognition engine 102E to be activated on the computing system 200. Contents of the audio buffer 114A before, during, or after a recognized phrase can also be provided to the activated activated specialized recognition engine 102E.

In the example shown in FIG. 2, the specialized recognition engines 102D and 102E are executed in parallel. The recognition events generated by the specialized recognition engines 102D and 102E can be arbitrated by the arbitrator 116, for example if both specialized recognition engines 102D and 102E are firing events at the same time. The recognition policy 104 might also specify how events are to be arbitrated by the arbitrator 116. For instance, and without limitation, the recognition policy 104 might specify that the receipt of recognition event from one of the specialized recognition engines 102D and 102E silences the other, that one of the specialized recognition engines 102D and 102E is to be given priority over the other, or that the specialized recognition engine 102D or 102E having the highest level of confidence in its recognition result is to be utilized.

The recognition policy 104 can also specify that the recognition threshold 108D associated with the specialized recognition engine 102D is to be modified (e.g. raised or lowered) when the specialized recognition engine 102E is activated. Alternately, the recognition policy 104 might specify that specialized recognition engine 102D is to be deactivated when the specialized recognition engine 102E is activated in order to reduce power consumption. The recognition policy 104 can also specify that specialized recognition engines 102 are to be deactivated or that a different model 106 is to be utilized by a specialized recognition engine 102 when an event is fired. In this manner, specialized recognition engines 102 can be activated in cascading manner, or deactivated, based upon the recognition policy 104 in order to implement a particular speech-driven UI and to meet desired power consumption requirements.

Specialized recognition engines 102 can also be activated and deactivated responsive to other events in other configurations. For example, and without limitation, the specialized recognition engine 102E might be deactivated when the computing system 200 enters a low power state. The specialized recognition engine 102E can then be reactivated when the computing system 200 exits the low power state.

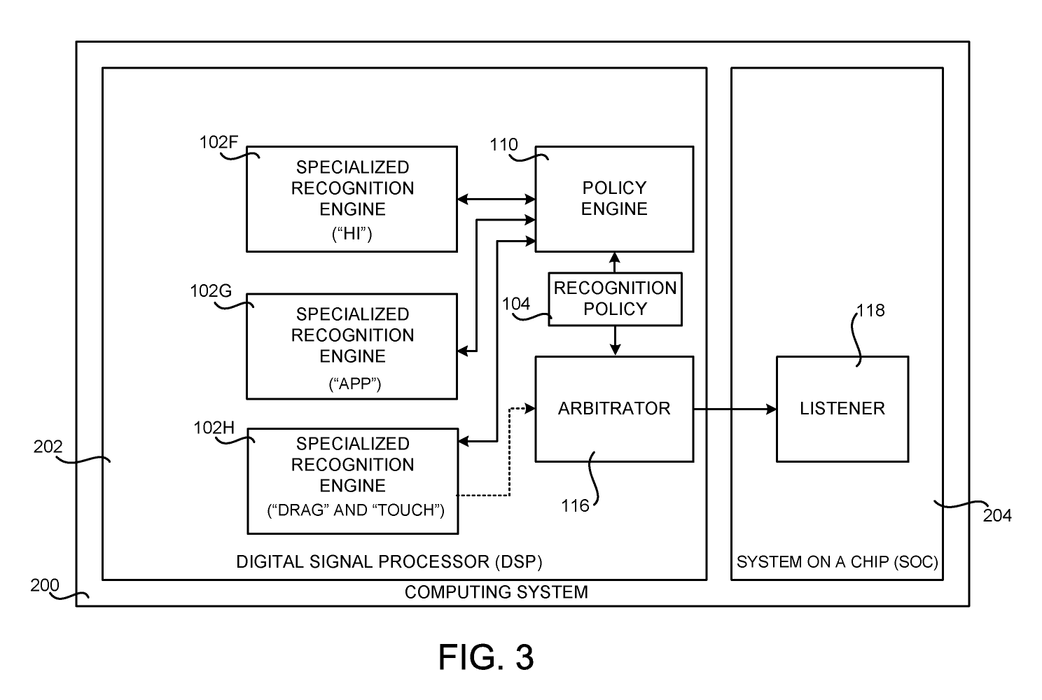

FIG. 3 is a system diagram showing aspects of the activation and operation of another example set of specialized recognition engines 102 executing on a computing system 200 in one particular configuration. In the example shown in FIG. 3, a specialized recognition engine 102F is initially executed that is configured to recognize the phrase “Hi.” The recognition policy 104 specifies that if the specialized recognition engine 102F recognizes the phrase “Hi”, then the specialized recognition engine 102G is to be activated. In this example, the specialized recognition engine 102G is configured to recognize the phrase “App.” The specialized recognition engine 102G can be executed in parallel with the specialized recognition engine 102F.

The recognition policy 104 also specifies that if the specialized recognition engine 102G recognizes the phrase “App”, then the specialized recognition engine 102H is to be activated. The specialized recognition engine 102H is configured to recognize the phrases “Drag” and “Touch.” The recognition policy 104 might also specify that the specialized recognition engine 102F is to be deactivated when the specialized recognition engine 102H is activated.

In the example shown in FIG. 3, the specialized recognition engine 102H is provided by the listener 118. Consequently, events generated by the specialized recognition engine 102H are provided to the listener 118 by the arbitrator 116. As also discussed above, contents of the audio buffer 114A before, during, or after the recognized phrase can also be provided to the listener 118. The listener 118 can utilize the contents of the audio buffer 114A to verify the recognition performed by the specialized recognition engine 12H and/or for other purposes. Although three specialized recognition engines 102F-102H are illustrated in FIG. 3, it is to be appreciated that many more specialized recognition engines 102 can be cascaded in a similar fashion in order to implement a desired recognition scenario.

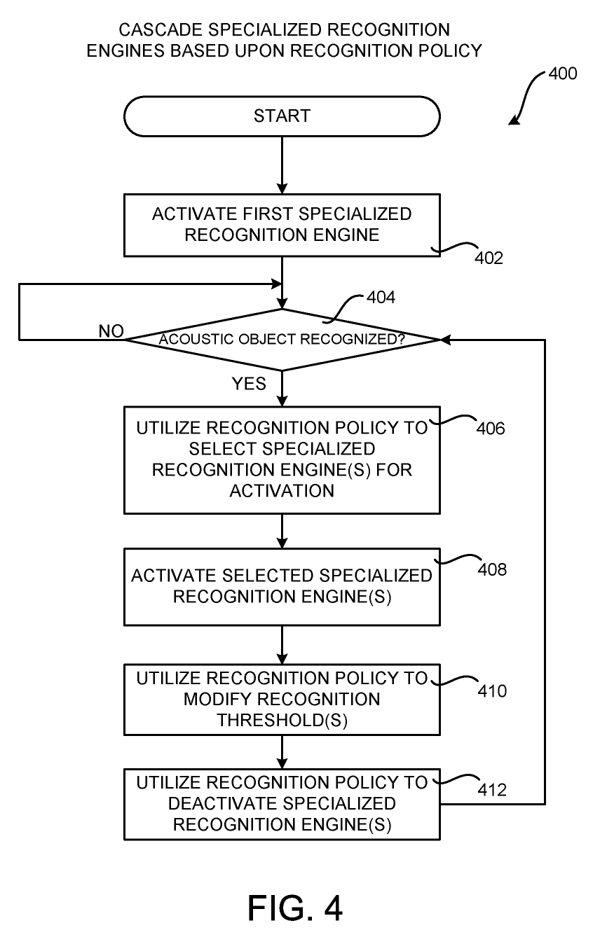

FIG. 4 is a flow diagram showing aspects of a routine 400 for cascading specialized recognition engines 102 based on a recognition policy 104, according to one configuration. It should be appreciated that the logical operations described herein with regard to FIG. 4, and the other FIGS., can be implemented (1) as a sequence of computer implemented acts or program modules running on a computing device and/or (2) as interconnected machine logic circuits or circuit modules within the computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in software, in firmware, in special purpose digital logic, and any combination thereof. It should also be appreciated that more or fewer operations can be performed than shown in the FIGS. and described herein. These operations can also be performed in a different order than those described herein.

The routine 400 begins at operation 402, where a first specialized recognition engine 102 can be activated on a computing device, such as the computing device 200. The routine 400 then proceeds from operation 402 to operation 404, where a determination is made as to whether the first specialized recognition engine 102 has recognized an acoustic object. As discussed above, if the first specialized recognition engine 102 has recognized an acoustic object, an event can be transmitted to both the policy engine 110 and the arbitrator 116 describing the recognized acoustic object.

If the first specialized recognition engine 102 has recognized an acoustic object, the routine 400 proceeds from operation 404 to operation 406. At operation 406, the policy engine 110 utilizes the recognition policy 104 to select one or more other specialized recognition engines 102 to be activated. Once the specialized recognition engines 102 have been selected, the routine 400 proceeds to operation 408, where the selected specialized recognition engines 102 are activated. The routine 400 then proceeds from operation 408 to operation 410.

At operation 410, the policy engine 110 might also utilize the recognition policy to modify the recognition thresholds 108 for currently activated specialized recognition engines 102. Likewise, the policy engine 110 might also utilize the recognition policy to select currently activated specialized recognition engines 102 for deactivation. The selected specialized recognition engines 102 are deactivated at operation 412. From operation 412, the routine 400 proceeds back to operation 404, where additional acoustic objects can be recognized, specialized recognition engines 102 can be activated or deactivated, and recognition thresholds 108 can be modified.

It is to be appreciated that the various software components described herein can be implemented using or in conjunction with binary executable files, dynamically linked libraries (“DLLs”), APIs, network services, script files, interpreted program code, software containers, object files, bytecode suitable for just-in-time (“JIT”) compilation, and/or other types of program code that can be executed by a processor to perform the operations described herein with regard to FIGS. 1-4. Other types of software components not specifically mentioned herein can also be utilized.

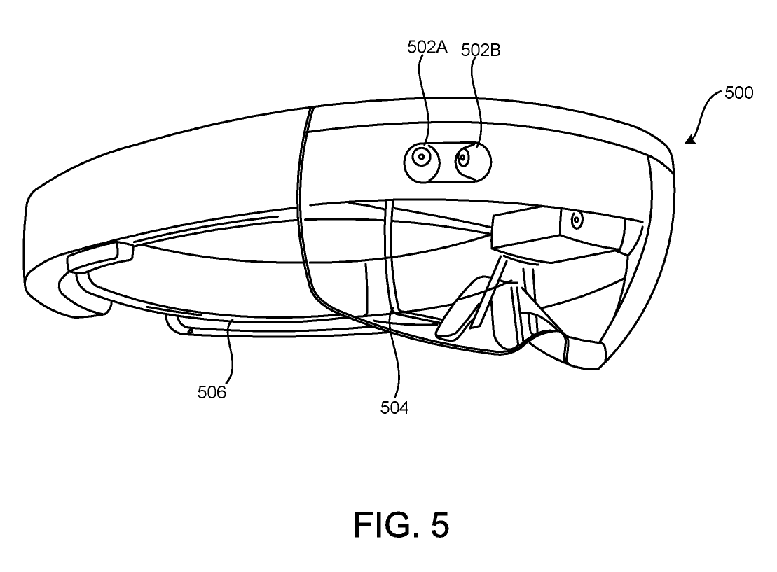

FIG. 5 is a schematic diagram showing an example of a head mounted augmented reality display device 500 that can be utilized to implement aspects of the technologies disclosed herein. As discussed briefly above, the various technologies disclosed herein can be implemented by or in conjunction with such a head mounted augmented reality display device 500 in order to reduce the power consumption required to implement a particular speech recognition scenario. In order to provide this functionality, and other types of functionality, the head mounted augmented reality display device 500 can include one or more sensors 502A and 502B and a display 504. The sensors 502A and 502B can include tracking sensors including, but not limited to, depth cameras and/or sensors, inertial sensors, and optical sensors.

In some examples, as illustrated in FIG. 5, the sensors 502A and 502B are mounted on the head mounted augmented reality display device 500 in order to capture information from a first person perspective (i.e. from the perspective of the wearer of the head mounted augmented reality display device 500). In additional or alternative examples, the sensors 502 can be external to the head mounted augmented reality display device 500. In such examples, the sensors 502 can be arranged in a room (e.g., placed in various positions throughout the room) and associated with the head mounted augmented reality display device 500 in order to capture information from a third person perspective. In yet another example, the sensors 502 can be external to the head mounted augmented reality display device 500, but can be associated with one or more wearable devices configured to collect data associated with the wearer of the wearable devices.

The display 504 can present visual content to the wearer (e.g. the user 102) of the head mounted augmented reality display device 500. In some examples, the display 504 can present visual content to augment the wearer's view of their actual surroundings in a spatial region that occupies an area that is substantially coextensive with the wearer's actual field of vision. In other examples, the display 504 can present content to augment the wearer's surroundings to the wearer in a spatial region that occupies a lesser portion the wearer's actual field of vision. The display 504 can include a transparent display that enables the wearer to view both the visual content and the actual surroundings of the wearer.

Transparent displays can include optical see-through displays where the user sees their actual surroundings directly, video see-through displays where the user observes their surroundings in a video image acquired from a mounted camera, and other types of transparent displays. The display 504 can present the visual content to a user such that the visual content augments the user's view of their actual surroundings within the spatial region.

The visual content provided by the head mounted augmented reality display device 500 can appear differently based on a user's perspective and/or the location of the head mounted augmented reality display device 500. For instance, the size of the presented visual content can be different based on the proximity of the user to the content. The sensors 502A and 502B can be utilized to determine the proximity of the user to real world objects and, correspondingly, to visual content presented on the display 504 by the head mounted augmented reality display device 500.

Additionally, or alternatively, the shape of the content presented by the head mounted augmented reality display device 500 on the display 504 can be different based on the vantage point of the wearer and/or the head mounted augmented reality display device 500. For instance, visual content presented on the display 504 can have one shape when the wearer of the head mounted augmented reality display device 500 is looking at the content straight on, but might have a different shape when the wearer is looking at the content from the side.

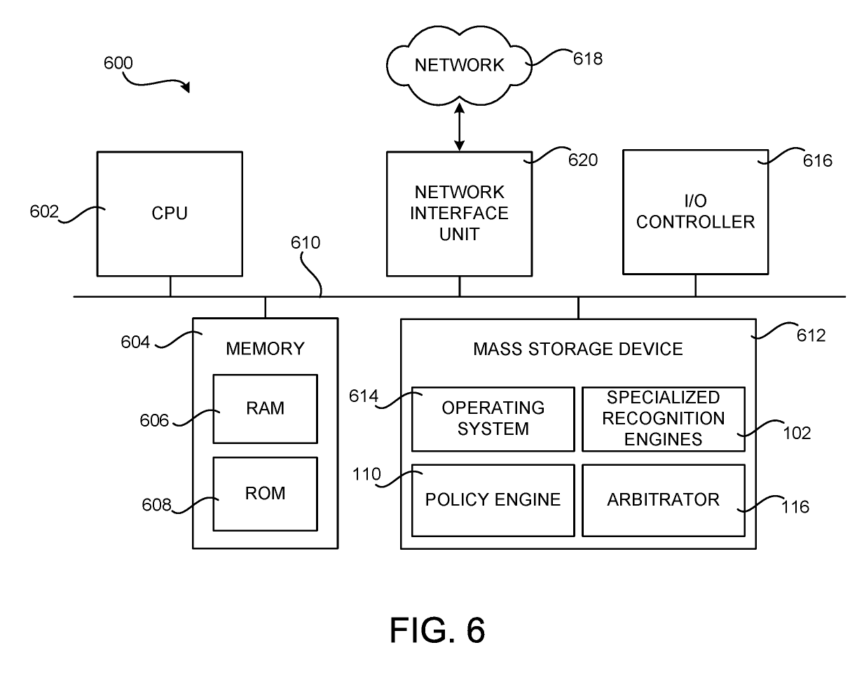

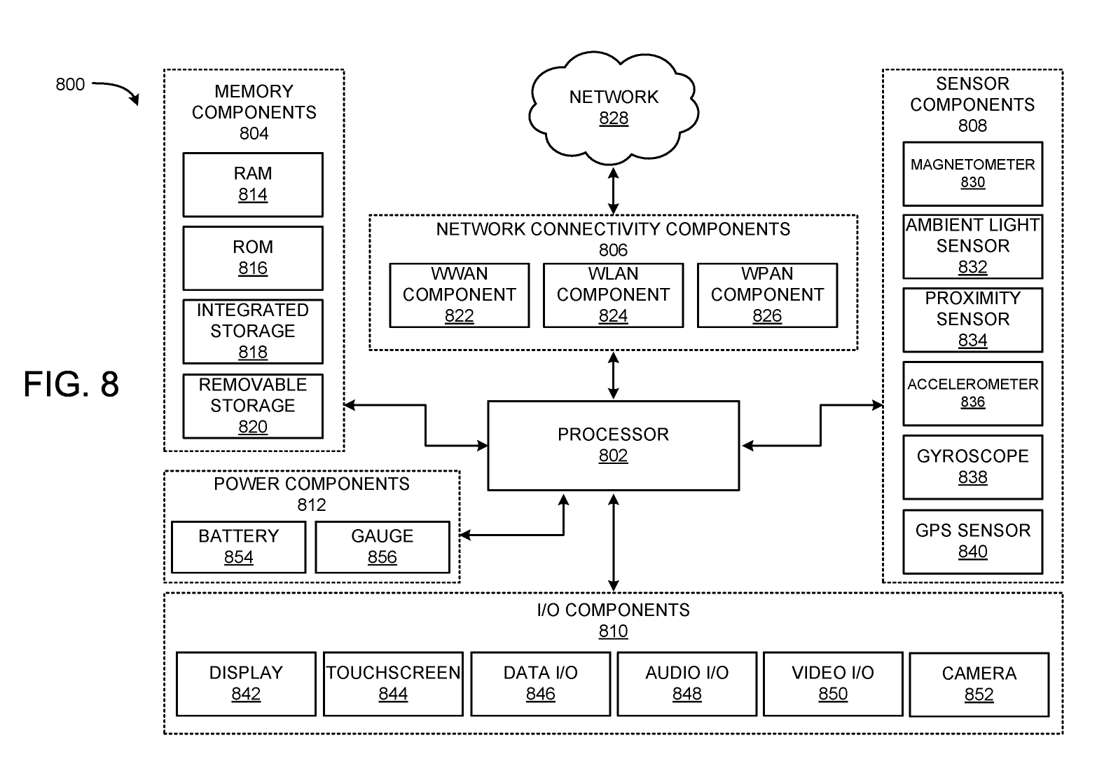

The head mounted augmented reality display device 500 can also include an audio capture device (not shown in FIG. 5) for capturing audio 112. The head mounted augmented reality display device 500 can also include one or more processing units (e.g. SoCs and DSPs) and computer-readable media (also not shown in FIG. 5) for executing the software components disclosed herein, including an operating system, the specialized recognition engines 102, the policy engine 110, the arbitrator 116, and one or more listeners 118. As the head mounted augmented reality display device 500 is battery powered in some configurations, the technologies disclosed herein can be utilized to improve the battery life of the head mounted augmented reality display device 500 while providing a robust speech-driven UI. Several illustrative hardware configurations for implementing the head mounted augmented reality display device 500 are provided below with regard to FIGS. 6 and 8.

FIG. 6 is a computer architecture diagram that shows an architecture for a computing device 600 capable of executing the software components described herein. The architecture illustrated in FIG. 6 can be utilized to implement the head mounted augmented reality display device 500 or a server computer, mobile phone, e-reader, smartphone, desktop computer, netbook computer, tablet or slate computer, laptop computer, game console, set top box, or another type of computing device suitable for executing the software components presented herein.

In this regard, it should be appreciated that the computing device 600 shown in FIG. 6 can be utilized to implement a computing device capable of executing any of the software components presented herein. For example, and without limitation, the computing architecture described with reference to the computing device 600 can be utilized to implement the head mounted augmented reality display device 500 and/or to implement other types of computing devices for executing any of the other software components described above. Other types of hardware configurations, including custom integrated circuits, DSPs, and SoCs can also be utilized to implement the head mounted augmented reality display device 500.

The computing device 600 illustrated in FIG. 6 includes a CPU 602, a system memory 604, including a random access memory 606 (“RAM”) and a read-only memory (“ROM”) 608, and a system bus 610 that couples the memory 604 to the CPU 602. A basic input/output system containing the basic routines that help to transfer information between elements within the computing device 600, such as during startup, is stored in the ROM 608. The computing device 600 further includes a mass storage device 612 for storing an operating system 614 and one or more programs including, but not limited to the specialized recognition engines 102, the policy engine 110, the arbitrator 116, and the listener 118. The mass storage device 612 can also be configured to store other types of programs and data described herein but not specifically shown in FIG. 6.

The mass storage device 612 is connected to the CPU 602 through a mass storage controller (not shown) connected to the bus 610. The mass storage device 612 and its associated computer readable media provide non-volatile storage for the computing device 600. Although the description of computer readable media contained herein refers to a mass storage device, such as a hard disk, CD-ROM drive, DVD-ROM drive, or universal storage bus (“USB”) storage key, it should be appreciated by those skilled in the art that computer readable media can be any available computer storage media or communication media that can be accessed by the computing device 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid state memory devices, CD-ROM, digital versatile disks (“DVD”), HD-DVD, BLU-RAY, or other optical storage disks, magnetic cassettes, magnetic tape, magnetic disk storage or other magnetic storage devices, or any other medium that can be used to store the desired information and which can be accessed by the computing device 600. For purposes of the claims, the phrase “computer storage medium,” and variations thereof, does not include waves or signals per se or communication media.

According to various configurations, the computing device 600 can operate in a networked environment using logical connections to remote computers through a network, such as the network 618. The computing device 600 can connect to the network 618 through a network interface unit 620 connected to the bus 610. It should be appreciated that the network interface unit 620 can also be utilized to connect to other types of networks and remote computer systems. The computing device 600 can also include an input/output controller 616 for receiving and processing input from a number of other devices, including a keyboard, mouse, touch input, or electronic stylus (not all of which are shown in FIG. 6). Similarly, the input/output controller 616 can provide output to a display screen (such as the display 504), a printer, or other type of output device (all of which are also not shown in FIG. 6).

It should be appreciated that the software components described herein, such as, but not limited to, the specialized recognition engines 102, the policy engine 110, the arbitrator 116, and the listener 118 can, when loaded into the CPU 602 (or a SoC or DSP) and executed, transform the CPU 602 (or a SoC or DSP) and the overall computing device 600 from a general-purpose computing device into a special-purpose computing device customized to facilitate the functionality presented herein. The CPU 602 can be constructed from any number of transistors or other discrete circuit elements, which can individually or collectively assume any number of states. More specifically, the CPU 602 can operate as a finite-state machine, in response to executable instructions contained within the software modules disclosed herein, such as but not limited to the specialized recognition engines 102, the policy engine 110, the arbitrator 116, and the listener 118. These computer-executable instructions can transform the CPU 602 by specifying how the CPU 602 transitions between states, thereby transforming the transistors or other discrete hardware elements constituting the CPU 602.

Encoding the software components presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software components presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computing device 600 in order to store and execute the software components presented herein. It should also be appreciated that the architecture shown in FIG. 6 for the computing device 600, or a similar architecture, can be utilized to implement other types of computing devices, including hand-held computers, embedded computer systems, mobile devices such as smartphones and tablets, and other types of computing devices known to those skilled in the art. It is also contemplated that the computing device 600 might not include all of the components shown in FIG. 6, can include other components that are not explicitly shown in FIG. 6, or can utilize an architecture completely different than that shown in FIG. 6.

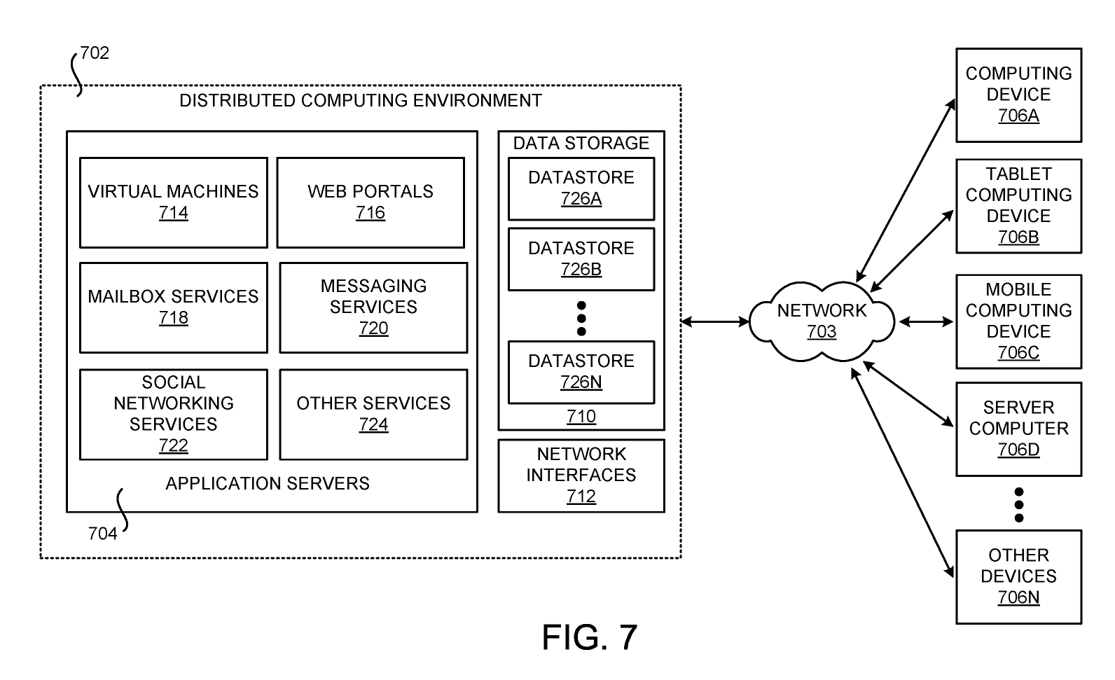

FIG. 7 shows aspects of an illustrative distributed computing environment 702 that can be utilized in conjunction with the technologies disclosed herein for cascading specialized recognition engines based on a recognition policy. According to various implementations, the distributed computing environment 702 operates on, in communication with, or as part of a network 703. One or more client devices 706A-706N (hereinafter referred to collectively and/or generically as “clients 706”) can communicate with the distributed computing environment 702 via the network 703 and/or other connections (not illustrated in FIG. 7).

In the illustrated configuration, the clients 706 include: a computing device 706A such as a laptop computer, a desktop computer, or other computing device; a “slate” or tablet computing device (“tablet computing device”) 706B; a mobile computing device 706C such as a mobile telephone, a smart phone, or other mobile computing device; a server computer 706D; and/or other devices 706N, such as the head mounted augmented reality display device 500 or a head mounted VR device.

It should be understood that virtually any number of clients 706 can communicate with the distributed computing environment 702. Two example computing architectures for the clients 706 are illustrated and described herein with reference to FIGS. 6 and 8. In this regard it should be understood that the illustrated clients 706 and computing architectures illustrated and described herein are illustrative, and should not be construed as being limiting in any way.

In the illustrated configuration, the distributed computing environment 702 includes application servers 704, data storage 710, and one or more network interfaces 712. According to various implementations, the functionality of the application servers 704 can be provided by one or more server computers that are executing as part of, or in communication with, the network 703. The application servers 704 can host various services, virtual machines, portals, and/or other resources. In the illustrated configuration, the application servers 704 host one or more virtual machines 714 for hosting applications, network services, or other types of applications and/or services. It should be understood that this configuration is illustrative, and should not be construed as being limiting in any way. The application servers 704 might also host or provide access to one or more web portals, link pages, web sites, and/or other information (“web portals”) 716.

According to various implementations, the application servers 704 also include one or more mailbox services 718 and one or more messaging services 720. The mailbox services 718 can include electronic mail (“email”) services. The mailbox services 718 can also include various personal information management (“PIM”) services including, but not limited to, calendar services, contact management services, collaboration services, and/or other services. The messaging services 720 can include, but are not limited to, instant messaging (“IM”) services, chat services, forum services, and/or other communication services.

The application servers 704 can also include one or more social networking services 722. The social networking services 722 can provide various types of social networking services including, but not limited to, services for sharing or posting status updates, instant messages, links, photos, videos, and/or other information, services for commenting or displaying interest in articles, products, blogs, or other resources, and/or other services. In some configurations, the social networking services 722 are provided by or include the FACEBOOK social networking service, the LINKEDIN professional networking service, the FOURSQUARE geographic networking service, the YAMMER office colleague networking service, and the like. In other configurations, the social networking services 722 are provided by other services, sites, and/or providers that might be referred to as “social networking providers.” For example, some web sites allow users to interact with one another via email, chat services, and/or other means during various activities and/or contexts such as reading published articles, commenting on goods or services, publishing, collaboration, gaming, and the like. Other services are possible and are contemplated.

The social networking services 722 can also include commenting, blogging, and/or microblogging services. Examples of such services include, but are not limited to, the YELP commenting service, the KUDZU review service, the OFFICETALK enterprise microblogging service, the TWITTER messaging service, and/or other services. It should be appreciated that the above lists of services are not exhaustive and that numerous additional and/or alternative social networking services 722 are not mentioned herein for the sake of brevity. As such, the configurations described above are illustrative, and should not be construed as being limited in any way.

As also shown in FIG. 7, the application servers 704 can also host other services, applications, portals, and/or other resources (“other services”) 724. The other services 724 can include, but are not limited to, any of the other software components described herein. It thus can be appreciated that the distributed computing environment 702 can provide integration of the technologies disclosed herein with various mailbox, messaging, blogging, social networking, productivity, and/or other types of services or resources. For example, and without limitation, some or all of the specialized recognition engines 102, the policy engine 110, the arbitrator, and the listener 118 can be executed on the clients 706 or within the distributed computing environment 702 such as, for instance, on the application servers 704. For instance, one or more of the specialized recognition engines 702 can be executed on a client 706 while the other components are executed by the application servers 704. The technologies disclosed herein can also be integrated with the network services shown in FIG. in other ways in other configurations.

As mentioned above, the distributed computing environment 702 can include data storage 710. According to various implementations, the functionality of the data storage 710 is provided by one or more databases operating on, or in communication with, the network 703. The functionality of the data storage 710 can also be provided by one or more server computers configured to host data for the distributed computing environment 702. The data storage 710 can include, host, or provide one or more real or virtual datastores 726A-726N (hereinafter referred to collectively and/or generically as “datastores 726”). The datastores 726 are configured to host data used or created by the application servers 704 and/or other data.

The distributed computing environment 702 can communicate with, or be accessed by, the network interfaces 712. The network interfaces 712 can include various types of network hardware and software for supporting communications between two or more computing devices including, but not limited to, the clients 706 and the application servers 704. It should be appreciated that the network interfaces 712 can also be utilized to connect to other types of networks and/or computer systems.

It should be understood that the distributed computing environment 702 described herein can implement any aspects of the software elements described herein with any number of virtual computing resources and/or other distributed computing functionality that can be configured to execute any aspects of the software components disclosed herein. According to various implementations of the technologies disclosed herein, the distributed computing environment 702 provides some or all of the software functionality described herein as a service to the clients 706. For example, and as described above, the distributed computing environment 702 can implement some or all of the specialized recognition engines 102, the policy engine 110, the arbitrator 116, and the listener 118. These components can be utilized to provide a speech-based UI for controlling the functions of a client 706 or for controlling components executing in the distributed computing environment 702.

It should also be understood that the clients 706 can also include real or virtual machines including, but not limited to, server computers, web servers, personal computers, mobile computing devices, smart phones, and/or other devices. As such, various implementations of the technologies disclosed herein enable any device configured to access the distributed computing environment 702 to utilize aspects of the functionality described herein.

Turning now to FIG. 8, an illustrative computing device architecture 800 will be described for a computing device that is capable of executing the various software components described herein. The computing device architecture 800 is applicable to computing devices that facilitate mobile computing due, in part, to form factor, wireless connectivity, and/or battery-powered operation. In some configurations, the computing devices include, but are not limited to, smart mobile telephones, tablet devices, slate devices, portable video game devices, or wearable computing devices such as the head mounted augmented reality display device 500 shown in FIG. 5.

The computing device architecture 800 is also applicable to any of the clients 706 shown in FIG. 7. Furthermore, aspects of the computing device architecture 800 are applicable to traditional desktop computers, portable computers (e.g., laptops, notebooks, ultra-portables, and netbooks), server computers, smartphone, tablet or slate devices, and other computer systems, such as those described herein with reference to FIG. 7. For example, the single touch and multi-touch aspects disclosed herein below can be applied to desktop computers that utilize a touchscreen or some other touch-enabled device, such as a touch-enabled track pad or touch-enabled mouse. The computing device architecture 800 can also be utilized to implement other types of computing devices for implementing or consuming the functionality described herein.

The computing device architecture 800 illustrated in FIG. 8 includes a processor 802, memory components 804, network connectivity components 806, sensor components 808, input/output components 810, and power components 812. In the illustrated configuration, the processor 802 is in communication with the memory components 804, the network connectivity components 806, the sensor components 808, the input/output (“I/O”) components 810, and the power components 812. Although no connections are shown between the individual components illustrated in FIG. 8, the components can be connected electrically in order to interact and carry out device functions. In some configurations, the components are arranged so as to communicate via one or more busses (not shown).

The processor 802 includes one or more CPU cores configured to process data, execute computer-executable instructions of one or more programs, such as the specialized recognition engines 102, the policy engine 110, the arbitrator 116, and the listener 118, and to communicate with other components of the computing device architecture 800 in order to perform aspects of the functionality described herein. The processor 802 can be utilized to execute aspects of the software components presented herein and, particularly, those that utilize, at least in part, a touch-enabled or non-touch gesture-based input.

In some configurations, the processor 802 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, 4K, and greater), video games, 3D modeling applications, and the like. In some configurations, the processor 802 is configured to communicate with a discrete GPU (not shown). In any case, the CPU and GPU can be configured in accordance with a co-processing CPU/GPU computing model, wherein the sequential part of an application executes on the CPU and the computationally intensive part is accelerated by the GPU.

In some configurations, the processor 802 is, or is included in, a SoC along with one or more of the other components described herein below. For example, the SoC can include the processor 802, a GPU, one or more of the network connectivity components 806, and one or more of the sensor components 808. In some configurations, the processor 802 is fabricated, in part, utilizing a package-on-package (“PoP”) integrated circuit packaging technique. Moreover, the processor 802 can be a single core or multi-core processor.

The processor 802 can be created in accordance with an ARM architecture, available for license from ARM HOLDINGS of Cambridge, United Kingdom. Alternatively, the processor 802 can be created in accordance with an x86 architecture, such as is available from INTEL CORPORATION of Mountain View, Calif. and others. In some configurations, the processor 802 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 804 include a RAM 814, a ROM 816, an integrated storage memory (“integrated storage”) 818, and a removable storage memory (“removable storage”) 820. In some configurations, the RAM 814 or a portion thereof, the ROM 816 or a portion thereof, and/or some combination of the RAM 814 and the ROM 816 is integrated in the processor 802. In some configurations, the ROM 816 is configured to store a firmware, an operating system 118 or a portion thereof (e.g., operating system kernel), and/or a bootloader to load an operating system kernel from the integrated storage 818 or the removable storage 820.

The integrated storage 818 can include a solid-state memory, a hard disk, or a combination of solid-state memory and a hard disk. The integrated storage 818 can be soldered or otherwise connected to a logic board upon which the processor 802 and other components described herein might also be connected. As such, the integrated storage 818 is integrated into the computing device. The integrated storage 818 can be configured to store an operating system or portions thereof, application programs, data, and other software components described herein.

The removable storage 820 can include a solid-state memory, a hard disk, or a combination of solid-state memory and a hard disk. In some configurations, the removable storage 820 is provided in lieu of the integrated storage 818. In other configurations, the removable storage 820 is provided as additional optional storage. In some configurations, the removable storage 820 is logically combined with the integrated storage 818 such that the total available storage is made available and shown to a user as a total combined capacity of the integrated storage 818 and the removable storage 820.

The removable storage 820 is configured to be inserted into a removable storage memory slot (not shown) or other mechanism by which the removable storage 820 is inserted and secured to facilitate a connection over which the removable storage 820 can communicate with other components of the computing device, such as the processor 802. The removable storage 820 can be embodied in various memory card formats including, but not limited to, PC card, COMPACTFLASH card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 804 can store an operating system. According to various configurations, the operating system includes, but is not limited to, the WINDOWS MOBILE OS, the WINDOWS PHONE OS, or the WINDOWS OS from MICROSOFT CORPORATION, BLACKBERRY OS from RESEARCH IN MOTION, LTD. of Waterloo, Ontario, Canada, IOS from APPLE INC. of Cupertino, Calif., and ANDROID OS from GOOGLE, INC. of Mountain View, Calif. Other operating systems can also be utilized.

The network connectivity components 806 include a wireless wide area network component (“WWAN component”) 822, a wireless local area network component (“WLAN component”) 824, and a wireless personal area network component (“WPAN component”) 826. The network connectivity components 806 facilitate communications to and from a network 828, which can be a WWAN, a WLAN, or a WPAN. Although a single network 828 is illustrated, the network connectivity components 806 can facilitate simultaneous communication with multiple networks. For example, the network connectivity components 806 can facilitate simultaneous communications with multiple networks via one or more of a WWAN, a WLAN, or a WPAN.

The network 828 can be a WWAN, such as a mobile telecommunications network utilizing one or more mobile telecommunications technologies to provide voice and/or data services to a computing device utilizing the computing device architecture 800 via the WWAN component 822. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”).

Moreover, the network 828 can utilize various channel access methods (which might or might not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications can be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 828 can be configured to provide voice and/or data communications with any combination of the above technologies. The network 828 can be configured or adapted to provide voice and/or data communications in accordance with future generation technologies.

In some configurations, the WWAN component 822 is configured to provide dual-multi-mode connectivity to the network 828. For example, the WWAN component 822 can be configured to provide connectivity to the network 828, wherein the network 828 provides service via GSM and UMTS technologies, or via some other combination of technologies. Alternatively, multiple WWAN components 822 can be utilized to perform such functionality, and/or provide additional functionality to support other non-compatible technologies (i.e., incapable of being supported by a single WWAN component). The WWAN component 822 can facilitate similar connectivity to multiple networks (e.g., a UMTS network and an LTE network).

The network 828 can be a WLAN operating in accordance with one or more Institute of Electrical and Electronic Engineers (“IEEE”) 104.11 standards, such as IEEE 104.11a, 104.11b, 104.11g, 104.11n, and/or a future 104.11 standard (referred to herein collectively as WI-FI). Draft 104.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 824 is configured to connect to the network 828 via the WI-FI access points. Such connections can be secured via various encryption technologies including, but not limited, WI-FI Protected Access (“WPA”), WPA2, Wired Equivalent Privacy (“WEP”), and the like.

The network 828 can be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 826 is configured to facilitate communications with other devices, such as peripherals, computers, or other computing devices via the WPAN.

The sensor components 808 include a magnetometer 830, an ambient light sensor 832, a proximity sensor 834, an accelerometer 836, a gyroscope 838, and a Global Positioning System sensor (“GPS sensor”) 840. It is contemplated that other sensors, such as, but not limited to temperature sensors or shock detection sensors, might also be incorporated in the computing device architecture 800.

The magnetometer 830 is configured to measure the strength and direction of a magnetic field. In some configurations the magnetometer 830 provides measurements to a compass application program stored within one of the memory components 804 in order to provide a user with accurate directions in a frame of reference including the cardinal directions, north, south, east, and west. Similar measurements can be provided to a navigation application program that includes a compass component. Other uses of measurements obtained by the magnetometer 830 are contemplated.

The ambient light sensor 832 is configured to measure ambient light. In some configurations, the ambient light sensor 832 provides measurements to an application program stored within one of the memory components 804 in order to automatically adjust the brightness of a display (described below) to compensate for low light and bright light environments. Other uses of measurements obtained by the ambient light sensor 832 are contemplated.

The proximity sensor 834 is configured to detect the presence of an object or thing in proximity to the computing device without direct contact. In some configurations, the proximity sensor 834 detects the presence of a user's body (e.g., the user's face) and provides this information to an application program stored within one of the memory components 804 that utilizes the proximity information to enable or disable some functionality of the computing device. For example, a telephone application program can automatically disable a touchscreen (described below) in response to receiving the proximity information so that the user's face does not inadvertently end a call or enable/disable other functionality within the telephone application program during the call. Other uses of proximity as detected by the proximity sensor 834 are contemplated.

The accelerometer 836 is configured to measure acceleration. In some configurations, output from the accelerometer 836 is used by an application program as an input mechanism to control some functionality of the application program. In some configurations, output from the accelerometer 836 is provided to an application program for use in switching between landscape and portrait modes, calculating coordinate acceleration, or detecting a fall. Other uses of the accelerometer 836 are contemplated.

The gyroscope 838 is configured to measure and maintain orientation. In some configurations, output from the gyroscope 838 is used by an application program as an input mechanism to control some functionality of the application program. For example, the gyroscope 838 can be used for accurate recognition of movement within a 3D environment of a video game application or some other application. In some configurations, an application program utilizes output from the gyroscope 838 and the accelerometer 836 to enhance control of some functionality. Other uses of the gyroscope 838 are contemplated.

The GPS sensor 840 is configured to receive signals from GPS satellites for use in calculating a location. The location calculated by the GPS sensor 840 can be used by any application program that requires or benefits from location information. For example, the location calculated by the GPS sensor 840 can be used with a navigation application program to provide directions from the location to a destination or directions from the destination to the location. Moreover, the GPS sensor 840 can be used to provide location information to an external location-based service, such as E911 service. The GPS sensor 840 can obtain location information generated via WI-FI, WIMAX, and/or cellular triangulation techniques utilizing one or more of the network connectivity components 806 to aid the GPS sensor 840 in obtaining a location fix. The GPS sensor 840 can also be used in Assisted GPS (“A-GPS”) systems. As discussed briefly above, data obtained from the sensor components 808 can be utilized to trigger activation of the specialized recognition engines 102. For instance, and without limitation, the accelerometer 836 can indicate that the device 800 has been picked up and cause one or more of the specialized recognition engines 102 to be activated in response thereto.

The I/O components 810 include a display 842, a touchscreen 844, a data I/O interface component (“data I/O”) 846, an audio I/O interface component (“audio I/O”) 848 for capturing the audio 112, a video I/O interface component (“video I/O”) 850, and a camera 852. In some configurations, the display 842 and the touchscreen 844 are combined. In some configurations two or more of the data I/O component 846, the audio I/O component 848, and the video I/O component 850 are combined. The I/O components 810 can include discrete processors configured to support the various interfaces described below, or might include processing functionality built-in to the processor 802.

The display 842 is an output device configured to present information in a visual form. In particular, the display 842 can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 842 is a liquid crystal display (“LCD”) utilizing any active or passive matrix technology and any backlighting technology (if used). In some configurations, the display 842 is an organic light emitting diode (“OLED”) display. Other display types are contemplated such as, but not limited to, the transparent displays discussed above with regard to FIG. 5.

The touchscreen 844 is an input device configured to detect the presence and location of a touch. The touchscreen 844 can be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or can utilize any other touchscreen technology. In some configurations, the touchscreen 844 is incorporated on top of the display 842 as a transparent layer to enable a user to use one or more touches to interact with objects or other information presented on the display 842. In other configurations, the touchscreen 844 is a touch pad incorporated on a surface of the computing device that does not include the display 842. For example, the computing device can have a touchscreen incorporated on top of the display 842 and a touch pad on a surface opposite the display 842.

In some configurations, the touchscreen 844 is a single-touch touchscreen. In other configurations, the touchscreen 844 is a multi-touch touchscreen. In some configurations, the touchscreen 844 is configured to detect discrete touches, single touch gestures, and/or multi-touch gestures. These are collectively referred to herein as “gestures” for convenience. Several gestures will now be described. It should be understood that these gestures are illustrative and are not intended to limit the scope of the appended claims. Moreover, the described gestures, additional gestures, and/or alternative gestures can be implemented in software for use with the touchscreen 844. As such, a developer can create gestures that are specific to a particular application program.

In some configurations, the touchscreen 844 supports a tap gesture in which a user taps the touchscreen 844 once on an item presented on the display 842. The tap gesture can be used for various reasons including, but not limited to, opening or launching whatever the user taps, such as a graphical icon representing the collaborative authoring application 110. In some configurations, the touchscreen 844 supports a double tap gesture in which a user taps the touchscreen 844 twice on an item presented on the display 842. The double tap gesture can be used for various reasons including, but not limited to, zooming in or zooming out in stages. In some configurations, the touchscreen 844 supports a tap and hold gesture in which a user taps the touchscreen 844 and maintains contact for at least a pre-defined time. The tap and hold gesture can be used for various reasons including, but not limited to, opening a context-specific menu.

In some configurations, the touchscreen 844 supports a pan gesture in which a user places a finger on the touchscreen 844 and maintains contact with the touchscreen 844 while moving the finger on the touchscreen 844. The pan gesture can be used for various reasons including, but not limited to, moving through screens, images, or menus at a controlled rate. Multiple finger pan gestures are also contemplated. In some configurations, the touchscreen 844 supports a flick gesture in which a user swipes a finger in the direction the user wants the screen to move. The flick gesture can be used for various reasons including, but not limited to, scrolling horizontally or vertically through menus or pages. In some configurations, the touchscreen 844 supports a pinch and stretch gesture in which a user makes a pinching motion with two fingers (e.g., thumb and forefinger) on the touchscreen 844 or moves the two fingers apart. The pinch and stretch gesture can be used for various reasons including, but not limited to, zooming gradually in or out of a website, map, or picture.

Although the gestures described above have been presented with reference to the use of one or more fingers for performing the gestures, other appendages such as toes or objects such as styluses can be used to interact with the touchscreen 844. As such, the above gestures should be understood as being illustrative and should not be construed as being limiting in any way.

The data I/O interface component 846 is configured to facilitate input of data to the computing device and output of data from the computing device. In some configurations, the data I/O interface component 846 includes a connector configured to provide wired connectivity between the computing device and a computer system, for example, for synchronization operation purposes. The connector can be a proprietary connector or a standardized connector such as USB, micro-USB, mini-USB, USB-C, or the like. In some configurations, the connector is a dock connector for docking the computing device with another device such as a docking station, audio device (e.g., a digital music player), or video device.

The audio I/O interface component 848 is configured to provide audio input for capturing the audio 112 and/or output capabilities to the computing device. In some configurations, the audio I/O interface component 846 includes a microphone configured to collect the audio 112. In some configurations, the audio I/O interface component 848 includes a headphone jack configured to provide connectivity for headphones or other external speakers. In some configurations, the audio interface component 848 includes a speaker for the output of audio signals. In some configurations, the audio I/O interface component 848 includes an optical audio cable out.

The video I/O interface component 850 is configured to provide video input and/or output capabilities to the computing device. In some configurations, the video I/O interface component 850 includes a video connector configured to receive video as input from another device (e.g., a video media player such as a DVD or BLU-RAY player) or send video as output to another device (e.g., a monitor, a television, or some other external display). In some configurations, the video I/O interface component 850 includes a High-Definition Multimedia Interface (“HDMI”), mini-HDMI, micro-HDMI, DISPLAYPORT, or proprietary connector to input/output video content. In some configurations, the video I/O interface component 850 or portions thereof is combined with the audio I/O interface component 848 or portions thereof.

The camera 852 can be configured to capture still images and/or video. The camera 852 can utilize a charge coupled device (“CCD”) or a complementary metal oxide semiconductor (“CMOS”) image sensor to capture images. In some configurations, the camera 852 includes a flash to aid in taking pictures in low-light environments. Settings for the camera 852 can be implemented as hardware or software buttons.

Although not illustrated, one or more hardware buttons can also be included in the computing device architecture 800. The hardware buttons can be used for controlling some operational aspect of the computing device. The hardware buttons can be dedicated buttons or multi-use buttons. The hardware buttons can be mechanical or sensor-based.

The illustrated power components 812 include one or more batteries 854, which can be connected to a battery gauge 856. The batteries 854 can be rechargeable or disposable. Rechargeable battery types include, but are not limited to, lithium polymer, lithium ion, nickel cadmium, and nickel metal hydride. Each of the batteries 854 can be made of one or more cells.

The battery gauge 856 can be configured to measure battery parameters such as current, voltage, and temperature. In some configurations, the battery gauge 856 is configured to measure the effect of a battery's discharge rate, temperature, age and other factors to predict remaining life within a certain percentage of error. In some configurations, the battery gauge 856 provides measurements to an application program that is configured to utilize the measurements to present useful power management data to a user. Power management data can include one or more of a percentage of battery used, a percentage of battery remaining, a battery condition, a remaining time, a remaining capacity (e.g., in watt hours), a current draw, and a voltage.

The power components 812 can also include a power connector (not shown), which can be combined with one or more of the aforementioned I/O components 810. The power components 812 can interface with an external power system or charging equipment via a power I/O component. Other configurations can also be utilized.

In view of the above, it is to be appreciated that the disclosure presented herein also encompasses the subject matter set forth in the following clauses:

Clause 1: A computer-implemented method, comprising: activating a first specialized recognition engine configured to recognize a first acoustic object on a computing system; determining that the first specialized recognition engine has recognized the first acoustic object; responsive to determining that the first specialized recognition engine has recognized the first acoustic object, selecting a second specialized recognition engine configured to recognize a second acoustic object based upon a recognition policy; and activating the selected second specialized recognition engine on the computing system.

Clause 2: The computer-implemented method of clause 1, further comprising modifying one or more recognition thresholds associated with the first specialized recognition engine responsive to determining that the first specialized recognition engine has recognized the first acoustic object.

Clause 3: The computer-implemented method of any of clauses 1-2, further comprising deactivating the first specialized recognition engine responsive to activating the selected second specialized recognition engine.

Clause 4: The computer-implemented method of any of clauses 1-3, further comprising providing contents of an audio buffer to the second specialized recognition engine.

Clause 5: The computer-implemented method of any of clauses 1-4, further comprising providing contents of an audio buffer to a program registered to receive a notification that the first specialized recognition engine has recognized the first acoustic object.

Clause 6: The computer-implemented method of any of clauses 1-5, wherein the computing system comprises a digital signal processor (DSP) and a system on a chip (SOC), wherein the first specialized recognition engine executes on the DSP, and wherein a program registered to receive a notification that the first specialized recognition engine has recognized the first acoustic object executes on the SOC.

Clause 7: The computer-implemented method of any of clauses 1-6, further comprising activating a third specialized recognition engine based upon the recognition policy.

Clause 8: The computer-implemented method of any of clauses 1-7, wherein the second specialized recognition engine is selected from a plurality of specialized recognition engines based upon the recognition policy.

Clause 9: The computer-implemented method of any of clauses 1-8, further comprising: determining that the computing system is entering a low power state; and deactivating the second specialized recognition engine in response to determining that the computing system is entering the low power state.

Clause 10: The computer-implemented method of any of clauses 1-9, further comprising: determining that the computing system is exiting a low power state; and reactivating the second specialized recognition engine responsive to determining that the computing system is exiting the low power state.

Clause 11: An apparatus, comprising: one or more processors; and at least one computer storage medium having computer executable instructions stored thereon which, when executed by the one or more processors, cause the apparatus to execute a first specialized recognition engine on the one or more processors, execute a policy engine on the one or more processors, receive an indication from the first specialized recognition engine at the policy engine that a first acoustic object has been recognized, responsive to the indication, select a second specialized recognition engine based upon a recognition policy, and execute the selected second specialized recognition engine on the one or more processors.

Clause 12: The apparatus of clause 11, wherein the at least one computer storage medium has further computer executable instructions stored thereon to: execute an arbitrator configured to receive an indication from the first specialized recognition engine that the first acoustic object has been recognized, and provide a notification to a program registered to receive a notification that the first specialized recognition engine has recognized the first acoustic object.

Clause 13: The apparatus of any of clauses 11-12, wherein the at least one computer storage medium has further computer executable instructions stored thereon to modify one or more recognition thresholds associated with the first specialized recognition engine.

Clause 14: The apparatus of any of any of clauses 11-13, wherein the at least one computer storage medium has further computer executable instructions stored thereon to deactivate the first specialized recognition engine.

Clause 15: The apparatus of any of clauses 11-14, wherein the at least one computer storage medium has further computer executable instructions stored thereon to provide contents of an audio buffer to the second specialized recognition engine.

Clause 16: A computer storage medium having computer executable instructions stored thereon which, when executed on a computing system, cause the computing system to: activate a first specialized recognition engine configured to recognize a first acoustic object on the computing system; receive an indication that the first specialized recognition engine has recognized the first acoustic object; select a second specialized recognition engine configured to recognize a second acoustic object based upon a recognition policy responsive to receiving the indication that the first specialized recognition engine has recognized the first acoustic object; and activate the selected second specialized recognition engine on the computing system.

Clause 17: The computer storage medium of clause 16, having further computer executable instructions stored thereon to modify one or more recognition thresholds associated with the first specialized recognition engine.

Clause 18: The computer storage medium of any of clauses 16-17, having further computer executable instructions stored thereon to deactivate the first specialized recognition engine.

Clause 19: The computer storage medium of any of clauses 16-18, having further computer executable instructions stored thereon to provide contents of an audio buffer to the second specialized recognition engine.

Clause 20: The computer storage medium of any of clauses 16-19, having further computer executable instructions stored thereon to activate a third specialized recognition engine configured to recognize a third acoustic object on the computing system.

Based on the foregoing, it should be appreciated that various technologies for cascading specialized recognition engines based upon a recognition policy have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

1. A computer-implemented method, comprising:
activating a first specialized recognition engine on a device, the first specialized recognition engine configured to recognize a first acoustic object on the device;
determining that the first specialized recognition engine has recognized the first acoustic object;
responsive to determining that the first specialized recognition engine has recognized the first acoustic object, selecting a second specialized recognition engine configured to recognize a second acoustic object on the device based upon a recognition policy;
activating the selected second specialized recognition engine on the device;
determining that the device is entering a low power state; and
deactivating the second specialized recognition engine on the device to reduce power consumption in response to determining that the device is entering the low power state.

2. The computer-implemented method of claim 1, further comprising modifying one or more recognition thresholds associated with the first specialized recognition engine responsive to determining that the first specialized recognition engine has recognized the first acoustic object.

3. The computer-implemented method of claim 1, further comprising deactivating the first specialized recognition engine responsive to activating the selected second specialized recognition engine.

4. The computer-implemented method of claim 1, further comprising providing contents of an audio buffer to the second specialized recognition engine.

5. The computer-implemented method of claim 1, further comprising providing contents of an audio buffer to a program registered to receive a notification that the first specialized recognition engine has recognized the first acoustic object.

6. The computer-implemented method of claim 1, wherein the device comprises a digital signal processor (DSP) and a system on a chip (SOC), wherein the first specialized recognition engine executes on the DSP, and wherein a program registered to receive a notification that the first specialized recognition engine has recognized the first acoustic object executes on the SOC.

7. The computer-implemented method of claim 1, further comprising activating a third specialized recognition engine based upon the recognition policy.

8. The computer-implemented method of claim 1, wherein the second specialized recognition engine is selected from a plurality of specialized recognition engines based upon the recognition policy.

9. (canceled)

10. The computer-implemented method of claim 1, further comprising:
determining that the device is exiting the low power state; and
reactivating the second specialized recognition engine responsive to determining that the device is exiting the low power state.

11. An apparatus, comprising:
one or more processors; and
at least one computer storage medium having computer executable instructions stored thereon which, when executed by the one or more processors, cause the apparatus to:
execute a first specialized recognition engine,
execute a policy engine,
receive an indication from the first specialized recognition engine that a first acoustic object has been recognized,
responsive to receiving the indication, select a second specialized recognition engine based upon a recognition policy of the policy engine,
execute the selected second specialized recognition engine to recognize a second acoustic object,
determine that the apparatus is entering a low power state; and
deactivate the second specialized recognition engine to reduce power consumption in response to determining that the apparatus is entering the low power state.

12. The apparatus of claim 11, wherein the at least one computer storage medium has further computer executable instructions stored thereon to:
execute an arbitrator based on the indication received from the first specialized recognition engine that the first acoustic object has been recognized, and
provide a notification to a program registered to receive the notification that the first specialized recognition engine has recognized the first acoustic object.

13. The apparatus of claim 11, wherein the at least one computer storage medium has further computer executable instructions stored thereon to modify one or more recognition thresholds associated with the first specialized recognition engine.

14. The apparatus of claim 11, wherein the at least one computer storage medium has further computer executable instructions stored thereon to deactivate the first specialized recognition engine.

15. The apparatus of claim 11, wherein the at least one computer storage medium has further computer executable instructions stored thereon to provide contents of an audio buffer to the second specialized recognition engine.

16. A computer storage medium having computer executable instructions stored thereon which, when executed on a computing device, cause the computing device to:
activate a first specialized recognition engine configured to recognize a first acoustic object on the computing device;
receive an indication that the first specialized recognition engine has recognized the first acoustic object;
select a second specialized recognition engine configured to recognize a second acoustic object based upon a recognition policy responsive to receiving the indication that the first specialized recognition engine has recognized the first acoustic object;
activate the selected second specialized recognition engine on the computing device;
determine that the computing device is entering a low power state; and
deactivate the second specialized recognition engine on the computing device to reduce power consumption in response to determining that the computing device is entering the low power state.

17. The computer storage medium of claim 16, having further computer executable instructions stored thereon to modify one or more recognition thresholds associated with the first specialized recognition engine.

18. The computer storage medium of claim 16, having further computer executable instructions stored thereon to deactivate the first specialized recognition engine.

19. The computer storage medium of claim 16, having further computer executable instructions stored thereon to provide contents of an audio buffer to the second specialized recognition engine.

20. The computer storage medium of claim 16, having further computer executable instructions stored thereon to activate a third specialized recognition engine configured to recognize a third acoustic object on the computing device.

21. The computer-implemented method of claim 1, further comprising determining that the second specialized recognition engine has recognized the second acoustic object prior to deactivating the second specialized recognition engine.
